(19) United States
(12) Patent Application Publication
(10) Pub. No.: US 2008/0289258 A1
(43) Pub. Date: Nov. 27, 2008

(54) Separation Structure for Isolating a Delimited Space from the External Environment

(76) Inventors: Elvio Gasperini, Castel S. Pietro Terme (Bologna) (IT); Vittoriano Marcheschi, Lappato (Lucca) (IT)

Correspondence Address: ARENT FOX LLP, 1050 CONNECTICUT AVENUE, N.W., SUITE 400, WASHINGTON, DC, 20036, US

(21) Appl. No.: 10/578,227

(22) PCT Filed: May 9, 2005
(86) PCT No.: PCT/IB05/01312

§ 371 Date: May 4, 2006

(30) Foreign Application Priority Data
May 25, 2004 (IT) BO2004A000331

(51) Int. Cl. E06B 7/16; B65B 65/00

(52) U.S. Cl. 49/477.1

(57) ABSTRACT

A separation structure (1) for isolating a delimited space (B) from the external environment (A), in particular a space (B) defined by an apparatus operating in the pharmaceutical material processing sector, comprises suitably assembled separator means (2, 3, 4) of the panel type or the like and seal means (G) inserted between the separator means (2, 3, 4); the seal means (G) being of the fluid dynamic expansion type and formed by at least two separately expanding tubular ducts (6, 8; 1:3, 14; 5, 5′); in each of the two tubular ducts (6, 8; 13, 14; 5, 5′) the supply of a pressurised or, if selected, negative pressure fluid being designed to be activated to cause the duct (6, 8; 13, 14; 5, 5′) to expand or contract.

### TECHNICAL FIELD

The present invention relates to a separation structure for isolating a delimited space from the external environment.

In particular, the invention is advantageously used for isolating from the external environment a space defined by an automatic machine operating in the pharmaceutical material processing sector, for example a tablet press for the production of tablets or a capsule filling machine for the production of capsules, or a similar apparatus, for example a unit for feeding pharmaceutical material to the machine, to which the following description makes specific reference without in any way limiting the scope of the invention.

### BACKGROUND ART

In the sector of automatic packaging/production machinery for processing pharmaceutical material, said machines, or their operating units, need to be isolated with a hermetic seal from the external environment, not only to avoid contamination with the outside during production, but also to allow sterilisation or washing of the component parts of the machines without fluid leaks during maintenance when production has stopped.

In general, sealed isolation is provided using separation structures of the type with separator surfaces or panels assembled to cover the space defined by the automatic machine or operating units which are part of it.

To allow access to the automatic packaging machine by technical operators responsible for making sure that the operating parts of the packaging machine function correctly and for maintenance, the above-mentioned separation structures are fitted with doors which have suitable seals able to connect the doors to the separator panels with a hermetic seal.

However, such seals very often tend to wear and become deformed over time in an uncontrollable way, which means that optimum hermetic isolation from the external environment at the doors can only be guaranteed with frequent substitution of the seals, which is very time consuming.

Moreover, the shape of such seals does not currently allow effective performance of the above-mentioned washing and sterilising operations, in the sense that small quantities of pharmaceutical material previously processed may often remain trapped in the seals, or in recesses created by them, even after washing operations, with the consequent dangerous contamination.

### DISCLOSURE OF THE INVENTION

The aim of the present invention is, therefore, to provide a hermetically sealed separation structure able to overcome the serious disadvantages of the prior art described above.

In particular, one aim of the present invention is to provide a separation structure which allows the hermetic isolation from the external environment of a space occupied by an automatic production/packaging machine, or units operating in conjunction with the machine, designed for processing pharmaceutical material, and at the same time allows optimum and effective washing or sterilisation of the machine or operating unit, eliminating subsequent dangerous contamination.

Accordingly, the present invention provides a separation structure for isolating a delimited space from the external environment, in particular a space defined by an apparatus operating in the pharmaceutical material processing sector, the structure comprising separator means of the panel type or the like, suitably assembled, and seal means inserted between said separator means. The structure is characterised in that the seal means are of the fluid dynamic expansion type and are formed by at least two separately expanding tubular ducts. Inside each of the two tubular ducts the supply of a pressurised or, if selected, negative pressure fluid is designed to be activated to cause expansion or contraction of the duct.

### BRIEF DESCRIPTION OF THE DRAWINGS

The technical features of the invention, in accordance with the above-mentioned aims, are evident in the claims herein, and the advantages are more clearly illustrated in the detailed description which follows with reference to the accompanying drawings, which schematically illustrate several preferred embodiments of the operating station disclosed without limiting the scope of the invention, and in which:

FIGS. 1a and 1b are two side views in cross-section and with some parts cut away for clarity of a preferred embodiment of the separation structure disclosed, corresponding to two different operating positions;

FIGS. 2a and 2b are two side views in cross-section and with some parts cut away for clarity of another embodiment of the separation structure disclosed, corresponding to two different operating positions; and

FIGS. 3a and 3b are two side views in cross-section and with some parts cut away for clarity of yet another embodiment of the separation structure disclosed, corresponding to two different operating positions.

### DESCRIPTION OF THE PREFERRED EMBODIMENTS OF THE INVENTION

With reference to the accompanying drawings, the numeral 1 denotes as a whole a separation structure designed to separate and isolate a delimited space B from the external environment A.

The space B is specifically a delimited space occupied by an automatic packaging/production machine (of the known type and not illustrated), in particular for processing and packaging pharmaceutical material, for example a tablet press for the production tablets or a capsule filling machine for the production of capsules, or a similar apparatus, for example a unit for conveying and feeding pharmaceutical material to the automatic machine.

The structure 1 is of the type with separator surfaces or panels assembled in the known way not illustrated, and basically comprises at least a first wall or panel 2 and at least a second wall or panel 3, between which a third panel 4 is positioned and connected.

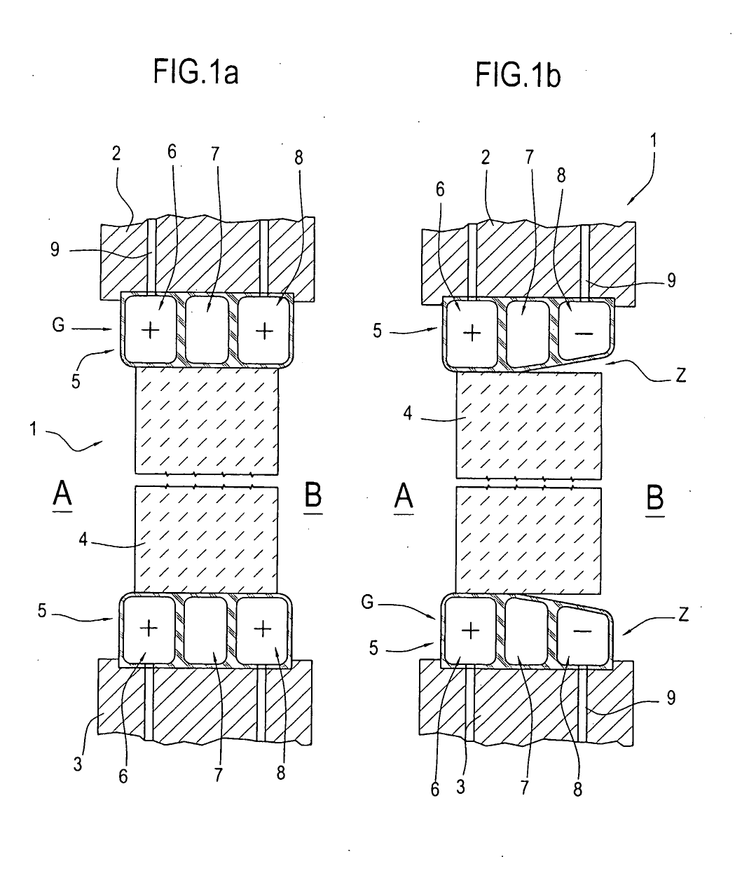

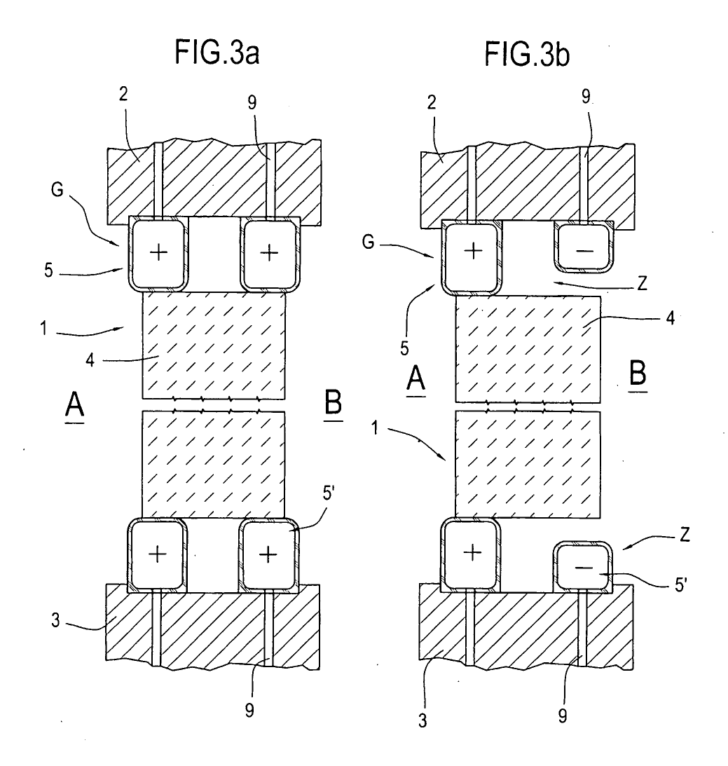

In the alternative embodiments illustrated in FIGS. 1a, 1b and in FIGS. 3a, 3b, the structure 1 preferably extends vertically with the panel 2 positioned at the top and the panel 3 at the bottom, and with the third panel 4 positioned between the two panels 2 and 3 consisting of a door 4 which can be opened to give access from the environment A to the space B, for example when the technical operators responsible for maintenance need to clean the automatic machine which defines the space B.

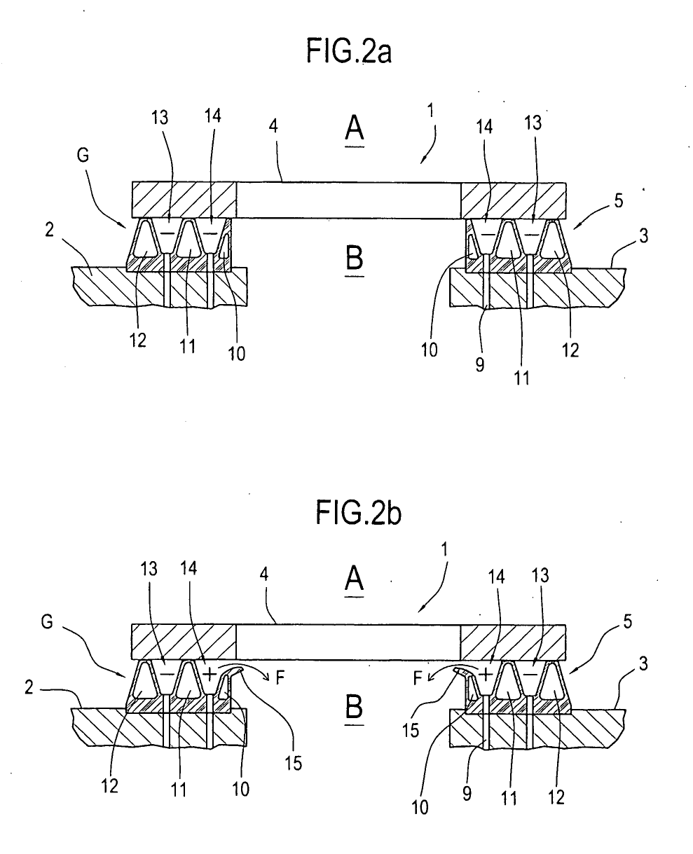

Alternatively, according to the embodiment illustrated in FIGS. 2a and 2b, the third panel 4 is preferably but without limiting the scope of the invention a cover 4 which closes the zone between the two panels 2 and 3 which are horizontal and therefore shuts off access from the external environment A to the space B which is located below. In this case the panels 2 and 3 are preferably walls of a container for pharmaceutical material which is part of the above-mentioned feed operating unit and the cover 4 is designed to close the container in which the space B is defined.

As illustrated in the accompanying drawings 1a, 1b, 2a, 2b and 3a and 3b, the panels 2 and 3 support a system G of hermetic seals.

The system G is of the fluid dynamic activated, expanding or inflatable type and comprises, connected to the panels 2, 3 and acting on the door 4, at least one hollow substantially tubular seal 5.

Known flow generator means, not illustrated, circulate a pressurised fluid inside the hollow tubular seal 5. For the sake of simplicity the pressurised fluid is labelled with the “+” symbol in the accompanying drawings. This causes the seal to greatly expand so that it hermetically seals the panel 4 on the panels 2 and 3, isolating the space B from the environment A. Alternatively, a negative pressure fluid, labelled with the “−” symbol in the accompanying drawings, is used when the seals must be greatly contracted to release the panel 4 from its connection with the panels 2 and 3.

According to the embodiment illustrated in FIGS. 1a and 1b, the seal 5 has three adjacent tubular chambers 6, 7 and 8 with a four-sided cross-section. The side chambers 6 and 8 form ducts 6, 8 in which there circulates the fluid (air) arriving from the generator means through channels 9 formed on the panels 2 and 3, whilst the central chamber 7 is a closed chamber.

Therefore, in practice, to separate and isolate the space B from the environment A by creating a hermetic seal between the door 4 and the panels 2 and 3, for example during the production cycle of the automatic machine which defines the space B, pressurised fluid is supplied and maintained in the ducts 6 and 8, thus causing the entire seal 5 to expand and bringing it into sealed contact with the door 4 (FIG. 1a).

When the automatic machine which defines the space B must be washed and/or sterilised (operation known with the terms CIP/SIP Cleaning in place/Sterilising in place), still keeping the pressurised fluid along the duct 6 of the seal 5, it is sufficient to suck the fluid out of the duct 8 of the seal 5, causing the portion of the seal 5 facing the space B to contract (FIG. 1b).

In this way, optimum washing and/or sterilising of the space B is possible, also effective in zones Z of the seal 5 and surrounding zones (FIG. 1b) which would not otherwise be reached, and where very often small quantities or fine dusts of pharmaceutical material processed accumulate, with the risk of subsequent contamination of the space B.

According to the alternative embodiment illustrated in FIGS. 3a and 3b, the system G comprises a pair of tubular seals 5 and 5′ set side by side in which chambers 5, 5′ with a four-sided cross-section are formed, in turn creating separate ducts 5 and 5′. With the pressurised fluid (air) in both the duct 5 and the duct 5′ the seals 5 and 5′ expand with consequent hermetic connection between the door 4 and the panels 2 and 3 (FIG. 3a), whilst still keeping the pressurised fluid in the duct 5 but sucking the fluid out of the duct 5′ causes the portion of the seal 5′ facing the space B to contract, allowing effective washing and/or sterilisation even in zones Z and surrounding zones (FIG. 3b) that would not otherwise be reached, and where very often small quantities or fine dusts of pharmaceutical material processed accumulate, with the risk of subsequent contamination of the space B.

According to the alternative embodiment illustrated in FIGS. 2a and 2b, in the structure 1 the seal 5 of the system G is formed by three closed chambers 10, 11 and 12 with a triangular cross-section, between which two compartments 13 and 14 are created, communicating via the channels 9 with the above-mentioned fluid flow generator means (not illustrated).

The compartments 13 and 14 are designed to be closed by the third panel or cover 4 to form ducts 13 and 14, said closure having a hermetic seal when the negative pressure fluid is maintained in the ducts 13 and 14, causing the ducts 13 and 14 to contract, consequently separating and isolating the space B from the external environment A in an airtight fashion (FIG. 2a).

In contrast, when the negative pressure effect is stopped only in the duct 14 and pressurised fluid is circulated in it (FIG. 2b) a seal 5 projection 15 facing the space B bends and opens towards the space B, releasing the fluid (arrow F) towards the space B. In this way any fine dusts or quantities of pharmaceutical material which may have accumulated at the seal 5 or in the surrounding zones can be released and so eliminated by the subsequent washing and/or sterilising of the space B.

In a possible preferred embodiment, when the negative pressure effect which hermetically seals the cover 4 has been stopped, the channel 9 corresponding to the duct 14 is optionally connected with a circuit that supplies a washing or sterilising liquid, so that the duct 14 and the projection 15 and the zones surrounding it can be washed even more effectively during space B cleaning.

Finally, it should be emphasised that in the above description of the structure 1, the seal 5 is preferably mounted on, or connected or fixed to the panels 2, 3 and acting on the panel 4, but alternatively the seal 5 may be connected or fixed to the panel 4 so that it acts on the panels 2 and 3. In particular, with reference to the embodiment illustrated in FIGS. 3a and 3b, the seal 5 may for example be fixed to the panels 2 and 3 and acting on the door 4, with the seal 5′ fixed to the door 4 and acting on the panels 2 and 3.

The invention described can be subject to modifications and variations without thereby departing from the scope of the inventive concept. Moreover, all the details of the invention may be substituted by technically equivalent elements.

1. A separation structure (1) for isolating a delimited space (B) from the external environment (A), in particular a space (B) defined by an apparatus operating in the pharmaceutical material processing sector, the structure (1) comprising suitable assembled separator means (2, 3, 4) of the panel type or the like, and seal means (G) inserted between the separator means (2, 3, 4); the structure being characterised in that the seal means (G) are of the fluid dynamic expansion type and are formed by at least two separately expanding tubular ducts (6, 8; 13, 14; 5, 5′); in each of the two tubular ducts (6, 8; 13, 14; 5, 5′) there being a supply of pressurised or, if selected, negative pressure fluid designed to be activated to cause the duct (6, 8; 13, 14; 5, 5′) to expand or contract.

2. The structure according to claim 1, characterised in that the separator means (2, 3, 4) comprise at least one pair consisting of a first separator panel (2) and a second separator panel (3), between which a third panel (4) is positioned and connected; the seal means (G) formed by the ducts (6, 8; 13, 14; 5, 5′) being connected to the first panel and the second panel (2, 3) and/or to the third panel (4).

3. The structure according to claim 2, characterised in that the third panel (4) positioned between the first panel and the second panel (2, 3) comprises a door (4) or cover (4) which can be opened to give access from the environment (A) to the space (B).

4. The structure according to any of the claims from 1 to 3, characterised in that the seal means (G) comprise a seal (5) in which there are at least two tubular chambers (6, 8) with a four-sided cross-section forming the two tubular ducts (6, 8).

5. The structure according to any of the claims from 1 to 3, characterised in that the seal means (G) comprise two seals (5, 5′), in each of which there is a tubular chamber (5, 5′) with a four-sided cross-section forming a tubular duct (5; 5′).

6. The structure according to any of the claims from 1 to 3, characterised in that the seal means (G) comprise a seal (5) in which there are three tubular chambers (10, 11, 12) with a triangular cross-section between which two compartments (13, 14) are formed, the compartment forming said two tubular ducts (13, 14); a seal (5) projection (15) being designed to bend and open towards the space (B) when pressurised fluid is supplied in one of the ducts (14).
